(19) United States
(12) Patent Application Publication
(10) Pub. No.: US 2015/0203356 A1
(43) Pub. Date: Jul. 23, 2015

(54) ACTIVATED CARBON HAVING HIGH ACTIVE SURFACE AREA

(71) Applicants: KANSAI COKE AND CHEMICALS CO., LTD., Hyogo (JP); MC Evolve Technologies Corporation, Hyogo (JP)

(72) Inventors: Junichi Yasumaru, Hyogo (JP); Kojiro Tenno, Hyogo (JP); Shoichi Takenaka, Hyogo (JP); Hirohiko Tomura, Hyogo (JP)

(21) Appl. No.: 14/416,871

(22) PCT Filed: Jul. 25, 2013
(86) PCT No.: PCT/JP2013/070183

§ 371 Date: Jan. 23, 2015

(30) Foreign Application Priority Data
Jul. 26, 2012 (JP) 2012-166108

(51) Int. Cl. C01B 31/08; B01J 20/28; B01J 20/20

(52) U.S. Cl. CPC C01B 31/08; B01J 20/20; B01J 20/28059; B01J 20/28061; B01J 20/28023

(57) ABSTRACT

The present invention provides activated carbon having excellent properties. The present invention consists of activated carbon, the key feature of which is an active surface area of at least 80 m²/g. In one preferred embodiment, the activated carbon consists of activated carbon fibers and is used for adsorption, and in a another preferred embodiment, the activated carbon also has a moisture adsorption rate (((mass B−mass A)/mass A)/×100%) of at least 40%, said moisture adsorption rate being determined from the mass (A) of the activated carbon after being dried for 24 hours at 115° C. and the mass (B) of the activated carbon after being kept for 24 hours in a thermo-hygrostat set to a temperature 25° C. and a relative humidity of 60%.

### TECHNICAL FIELD

The present invention relates to an activated carbon having an increased active surface area.

### BACKGROUND ART

Activated carbons are used in various applications for adsorption because of their increased specific surface areas and developed pore structures. In order to effectively exhibit functions in such applications, there is an increasing demand for activated carbons that have appropriate physical properties. It is known that physical properties such as adsorption performance of activated carbons are influenced by the structure of the activated carbons and mainly by the specific surface area of the activated carbons, and also it has been studied that a pore size distribution or a surface structure of an activated carbon is suitably controlled according to the size or polarity of an adsorbate. It is also known that increasing not a basal plane but rather an edge site (active surface area) of a graphene sheet (graphene) is effective to improve reactivity of activated carbons (J. Randin et al., J. Electron. Chem., 86 (1972) p. 257). Technologies for enhancing various properties by improving activated carbons have been proposed.

For example, Patent Document 1 discloses a technology in which a carbon nanofiber, of which the intensity ratio of a specific band measured by Raman spectroscopic analysis is controlled, is subjected to a heating treatment in a hydrogen atmosphere, thereby increasing an edge site ratio and a pore volume, and enhancing electrical capacitance.

Patent Document 2 discloses a technology in which a carbon fiber having an active surface area ratio of 1.5% or more is subjected to an electrolytic oxidation surface treatment to control the atomic ratio of oxygen and carbon at the carbon fiber surface, thereby enhancing the adhesion between carbon fibers and resin while suppressing a decrease in tensile strength.

Furthermore, Patent Document 3 discloses a technology in which an area ratio of an edge site at the surface of an activated carbon is allowed to be 20% or more, thereby enhancing the electrostatic capacity density of an activated, carbon for capacitor.

As disclosed in the above conventional arts, an active surface area (edge site) of an activated carbon has attracted attention as one of factors improving physical properties of an activated carbon, and hence, various studies have been conducted. However, the details still have not been clarified.

### PATENT DOCUMENTS

[Patent Document 1] JP-A-2005-023468

[Patent Document 2] JP-A-H05-302263

[Patent Document 3] JP-A-200189244

### DISCLOSURE OF THE INVENTION

### Problems to be Solved by the Invention

Along with the development of industrial technologies, performance required for an activated, carbon has been diversified, and along with the expanding of applications of an activated carbon, further improvement in performance of an activated carbon has been required. For example, an activated carbon is utilized for an application of adsorption, and in order to improve processing efficiency and the like, an activated carbon having a high adsorption performance has been awaited.

The present invention has been made in view of the above problems, and an object of thereof is to provide an activated carbon having superior physical properties to those of conventional activated carbons. In particular, the present invention is aimed at providing an activated carbon of which the physical properties useful for increasing adsorption performance are improved.

### Means for Solving the Problems

A feature of the present invention which can solve above problems is an activated carbon having an active surface area of 80 m²/g or more.

The above activated carbon is preferably comprises activated carbon fibers. Also, the activated carbon is preferably used for adsorption. And the activated carbon is preferably used for adsorption of moisture in air.

Furthermore, the above activated carbon, which is preferable, having a moisture adsorption rate (((mass B−mass A)/mass A)×100) of 40% or more,

the moisture adsorption rate being determined from the mass A of the activated carbon after being dried at 115° C. for 24 hours and the mass B of the dried activated carbon after being kept for 24 hours in a thermo-hygrostat set to a temperature of 25° C. and a relative humidity of 60%.

The activated carbon comprises an alkali-activated carbon is preferable.

An adsorbent using the above activated carbon is also include in the present invention.

### Advantageous Effects of the invention

According to the present invention, an activated carbon having excellent adsorption performance can be obtained by increasing the active surface area of the activated carbon.

### BRIEF DESCRIPTION OF THE DRAWINGS

FIG. 1 is a view illustrating the relationship between the specific surface area and the moisture adsorption rate of activated carbons; and

FIG. 2 is a view illustrating the relationship between the specific surface area and the active surface area of activated carbons.

### MODE FOR CARRYING OUT THE INVENTION

Adsorption performance of an activated carbon to a substance having a polar group (hereinafter, may often be referred to as “polar substance”) such as water is improved by increasing the specific surface area of an activated carbon. However, it is known that the adsorption performance is no longer improved when the specific surface reaches a certain value.

The inventors of the present invention have studied in order to further improve the adsorption performance and have found that an active surface (edge site) has a high adsorbing capability for a polar substance and it is more effective to increase the active surface area as compared with increasing the specific surface area. Particularly, it has been found that the adsorption performance is remarkably improved if the activated carbon has an active surface area that is equal to or higher than a specific level, and the invention has been made based on this finding.

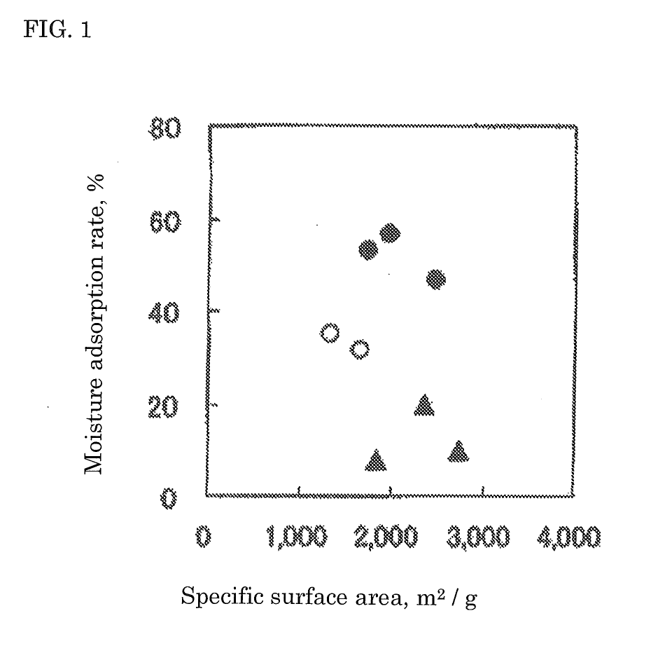

An activated carbon of the present invention has an active surface area of 80 m²/g or more. It was found through the experiments by the inventors that if the activated carbon has the active surface area of less than 80 m²/g, the adsorption rate of a polar substance is low even if the specific surface is increased. FIG. 1 is a graph showing the relationship between the moisture adsorption rate and the specific surface area based on the results of Examples described later. In FIG. 1, black circles “” all indicate the examples of an active surface area of 80 ms/g or more (Samples No. 2, No. 0 and No. 6), both white circles “∘” and black triangles “▴” indicate the examples of an active surface area of less than 80 m²/g (∘: Samples No. 9 and No. 10, ▴: Samples No. 11 to No. 13). First, with regard to the relationship between the active surface area and the moisture adsorption rate, it can be confirmed that the examples of the active surface area of 80 m²/g or more (marked by ) exhibit a high moisture adsorption rate of 40% or more, whereas the examples of the active surface area of less than 80 m²/g (marked by ∘and ▴) exhibit a low moisture adsorption rate of less than 40%. Next with regard to the relationship between the specific surface area and the moisture adsorption rate, it cannot be said that the moisture adsorbed amount increases (marked by ▴) even though the specific surface area is increased, and it can be confirmed that the active surface area has a significant influence on the moisture adsorption rate as described above.

From the result of these considerations, it can be concluded that, in order to improve adsorption performance of an activated carbon, rather than increasing the specific surface area that has been conventionally thought to be effective, increasing of the active surface area is more effective and the moisture adsorption rate can be improved by increasing the active surface area.

In the present invention, as the physical properties of the activated carbon significantly improving adsorption performance, the active surface area is 80 m²/g or more, preferably 90 m²/g or more, and more preferably 100 m²/g or more. Note that a higher active surface area is preferable, and the upper limit is not particularly limited. For example, the desirable physical properties can be exhibited even if the active surface area is 130 m²/g or less, particularly 110 m²/g or less.

Here, the active surface area of the activated carbon can be determined by the measurement method described in Examples described later.

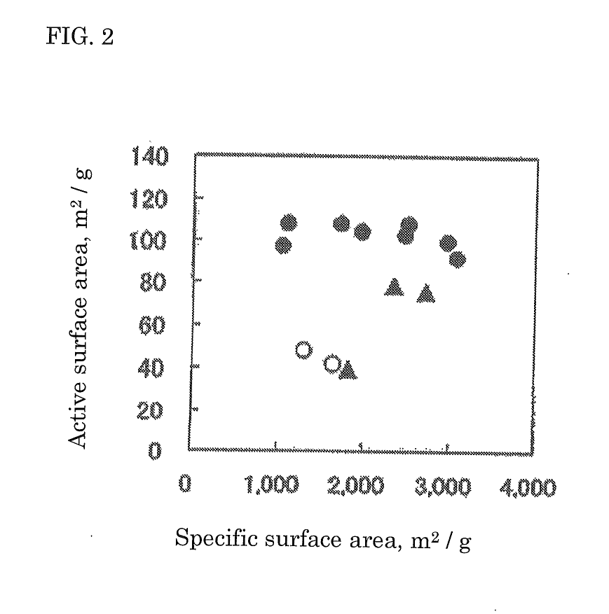

The specific surface area of the activated carbon of the present invention is not particularly limited. It became clear from the results of the experiments conducted by the inventors that it is possible to obtain the activated carbon having an active surface area of 80 m²/g or more regard less of the specific surface area of the activated carbon. FIG. 2 is a graph showing the relationship between the active surface area and the specific surface area based on the results of Examples described later. In FIG. 2, all of black circles “” indicate the examples of the active surface area of 80 m²/g or more (Samples No. 1 to No. 8). both white circles “∘” and black triangle “▴” indicate the examples of the active surface area of less than 80 m²/g (∘: Samples No. 9 and No. 10, ▴: Samples No. 11 to No. 13). As is apparent from FIG. 2, a unique proportional relation is not observed between the increase of the specific surface area and the increase of the active surface area, and it is confirmed that it is possible to obtain the activated carbon having an active surface area of 80 m²/g or more within a wide range of the specific surface area. Furthermore, as described above, the adsorption performance of the activated carbon having an active surface area of 80 m²/g or more shows a high effect regardless of the specific surface area (see FIG. 1).

Accordingly, in the present invention, the upper limit and the lower limit of the specific surface area of the activated carbon are not particularly limited from the viewpoint of the adsorption performance. However, if the specific surface area of the activated carbon increases, the adsorbing capability tends to also be unproved, and hence, the specific surface area of the activated carbon is preferably 500 m²/g or more, more preferably 750 m²/g or more. Furthermore, if the specific surface area excessively increases, the strength of the activated carbon may decrease, and hence, the specific surface area of the activated carbon is preferably 4000 m²/g or less, more preferably 3500 m²/g or less. Here, the specific surface area of the activated carbon is a value determined by the BET method for measuring a nitrogen adsorption isotherm of porous carbon.

Furthermore, the pore volume (total pore volume) and the pore diameter of the activated carbon are not particularly limited. The pore volume and the pore diameter of the activated carbon may be appropriately adjusted depending on a substance to be adsorbed. For example, the total pore volume is preferably 0.2 cm³/g or more, more preferably 1.0 cm³/g or more, and is preferably 3.0 cm³/g or less, more preferably 1.5 cm³/g or less. Here, the total pore volume means a value determined by the BET method for measuring a nitrogen adsorption amount when the relative pressure P/P₀ (P: gas pressure of an adsorbate under an adsorption equilibrium, P₀: saturated vapor pressure of an adsorbate at an adsorption temperature) is up to 0.93. For example, the average pore diameter is preferably 1.0 nm or more, more preferably 1.2 nm or more, and preferably 4.0 nm or less, more preferably 3.0 nm or less. Here, the average pore diameter means a value calculated by using the specific surface area of alkali-activated carbon determined by the BET method and the total pore volume of alkali-activated carbon determined by the BET method and assuming that the shape of the pore is cylindrical, which can be determined from the following expression (1).

$$[ Expression 1 ]$$

$$Average pore diameter = \frac{4 \times total pore volume by the BET method}{Specific surface area by the BET method} \qquad ( 1 )$$

Note that the active surface area, the specific surface area, the total pore volume, the average pore diameter and the like of the alkali-activated carbon of the present invention can be adjusted by appropriately selecting an activated carbon raw material, heating conditions of alkali activation or the like.

As for adsorption performance of the activated carbon in the present invention, a moisture adsorption rate (((mass B−mass A)/mass A)×100) is preferably 40% or more, more preferably 45% or more, further more preferably 50% or more, the moisture adsorption rate being determined from the mass A of the activated carbon after being dried at 115° C. for 24 hours and the mass B of the dried activated carbon after being kept for 24 hours in a thermo-hygrostat to a temperature of25° C. and a relative humidity of 60%. There is no particular upper limit of the moisture adsorption rate, and a higher rate is more preferable. In the present invention, the adsorption performance is represented by the moisture adsorption rate. However, since the activated carbon having a higher adsorption performance for water exhibits an excellent adsorption performance also for various polar substances, the adsorption performance of the activated carbon of the present invention is not limited to adsorption performance for water. Therefore, the activated carbon of the present invention can be used for an adsorption treatment and is especially preferable as adsorbents in various fields of adsorption.

Examples of types of the activated carbon include powdered activated carbons using sawdust, wood chips, charcoal, peat and the like as a raw material; granular activated carbons using charcoal, coconut shell charcoal, coal, oil carbon, phenol and the like as a raw material; activated carbon fibers using carbonaceous materials (petroleum pitch, coal pitch, coal-tar pitch, and the composite thereof or the like), synthetic resin (phenol resin, polyacryionitrile (PAN), polyimide, furan resin or the like), cellulosic fibers (paper, cotton fibers or the like) and the like as a raw material. Among these, activated carbon fibers are preferable in the present invention. As also shown in Table 1 of Examples described later, the activated carbon fibers (No. 1 to No. 8) are more advantageous than the powdered (powder) activated carbons (No. 11 to No. 13) in order to allow the active surface area to be 80 m²/g or more. In the case of the powder activated carbon, the moisture adsorption rate to the active surface area is 20% or less, whereas in the case of the activated carbon fibers having an active surface area of 80 m²/g or more, the moisture adsorption rate to the active surface area is 40% or more, indicating that a high moisture adsorption effect can be achieved.

With regard to the relationship between the activation treatment and the active surface area of an activated carbon, Patent Document 1 discloses that, when an activated carbon raw material is subjected to an activation treatment, an edge site (active surface) is corroded more selectively compared to a basal plane and hence the basal plane is exposed. As a result, the edge site decreases even though the specific surface area increases, suggesting that the property that the active surface area and the specific surface area cannot be increased at the same time. This is also indicated by No. 9 and No. 10 that were steam-activated shown in Table 1 of Examples described later and can be understood from the met that the specific surface area increases from 1330 m²/g (No. 9) to 1670 m²/g (No. 10) and the active surface area (edge area) decreases from 47.2 m²/g (No. 9) to 41.4 m²/g (No. 10) when being steam-activated.

However, when being alkali-activated, each of No. 5 (1120 m²/g) and No. 6 (1740 m²/g) having a specific surface area nearly equal to that of No. 9and No. 10 has an active surface area of 100 m²/g or more, showing tendencies different from the cases when being steam-activated.

Therefore, in the present invention, the activated carbon fibers obtained by alkali-activating is desirable. By subjecting to an alkali activation treatment, not only the active surface area of the activated carbon can be effectively increased but also the activated carbon fibers having a high adsorption performance can be obtained.

Note that both the powder activated carbon and the granular activated carbon that have been alkali-activated have an increased active surface area compared with the activated carbon that has been steam-activated, but have the lower adsorption performance compared with the activated carbon fibers that have been alkali-activated.

The fiber diameter of the activated carbon fibers is not particularly limited. However, the fibers having a too small diameter are easily cut, and on the other hand, in some activated carbon fibers having a too large diameter, the activation can become difficult to progress uniformly. Accordingly, the fiber diameter may preferably be 0.1 to 200 μm, for example, preferably about 0.1 to 50 μm.

As described above, the activated carbon of the present invention has an active surface area of 80 m²/g or more. For the activated carbon, the activated carbon fibers are preferred, with the alkali-activated carbon being particularly preferred. The activated carbon of the present invention can be used for various known adsorptions. It is furthermore preferably used for adsorption of moisture in air. The activated carbon of the present invention is excellent in adsorption performance and thus preferable as an adsorbent.

With regard to a method tor producing the activated carbon of the present invention having the active surface area of 80 m²/g or more, a description will be made taking the case of producing activated carbon fibers as an example. Even in the case of producing a powdered activated carbon, the method may be modified accordingly with reference to the following description.

As the starting raw material (activated carbon raw material) of the activated carbon fibers, there is no particular limitation, and various known materials such as carbonaceous materials, synthetic resin, cellulosic fibers or the like as described above may be used. Among these, carbonaceous materials (especially petroleum pitch) and synthetic resin (especially, phenol resin) are preferred because, by alkali-activating these materials, alkali-activated carbon fibers having enhanced effects of increasing the active surface area and excellent adsorption performance can be obtained.

A method for producing precursor fibers of the activated carbon fibers is not particularly limited, and various known methods such as the electrostatic spinning method, the blend spinning method and the like may be employed. In the electrostatic spinning method, the precursor of the activated carbon fibers can be produced in a manner in which a solution of a starting raw material of the activated carbon fibers being dissolved in a solvent is discharged in an electrostatic field formed between electrodes.

In the blend spinning method, the precursor for the activated carbon fibers can be produced by mixing a starting raw material of the activated carbon fibers and thermoplastic resin, spinning this mixture, and then removing the thermoplastic resin.

As a carbonization treatment of the precursor of the activated carbon fibers, the precursor may be heat-treated under an inert gas atmosphere such as nitrogen. The treatment temperature and the treatment time are not particularly limited. For example, the carbonization treatment temperature is preferably 400° C. or higher, more preferably 500° C. or higher, and preferably 950° C. or lower, more preferably 900° C. or lower. The carbonization treatment time is preferably 0.1 hours or longer, more preferably 0.5 hours or longer, and preferably 4.0 hours or shorter, more preferably 3.0 hours or shorter.

Next, the carbon fibers obtained by the above carbonization treatment is subjected to an alkali activation treatment. The alkali activation treatment is a treatment in which the above carbon fibers and an alkali activator are mixed and the mixture is heated, thereby making the activated carbon raw material porous with increasing the active surface area. A hydrate of alkali metal may be used as the activator used, here, and as examples thereof, hydroxides such as sodium hydroxide, potassium hydroxide, lithium hydroxide or the like can be given. Among these, potassium hydroxide is preferable.

The amount of the activator used may be appropriately adjusted depending on a desired active surface area because a higher mixing ratio of the activator tends to increase the active surface area. For example, as for the amount of the activator used, it is preferred that a mass ratio of the amount of the activator used and the activated, carbon raw material (alkali activator/activated carbon raw material) be preferably 0.5 or more, more preferably 1.0 or more, further more preferably 2.0 or more, and preferably 5.0 or less, more preferably 4.5 or less, further more preferably 4.0 or less.

In order to promote mixing of the activator and the activated carbon raw material to enhance the activation effect, the activated carbon raw material and the activator are mixed with water. The mixing amount of water at this time may be an amount that is sufficient to melt the activator and can be 0.05 to 10 times the mass of the activator.

The annealing temperature the mixture of the activated carbon raw material and the activator is preferably 500° C. or higher, more preferably 600° C. or higher, and preferably 950° C. or lower, more preferably 900° C. or lower. After reaching the annealing temperature, the heating and holding time is approximately for three hours or shorter. Furthermore, when firing, the mixture that has been held in advance at a temperature of 850 to 450° C. for 30 to 60 minutes (primary heating) may be fired. Heating under such firing conditions make it possible to increase the active surface area. The atmosphere at the heating is preferably an atmosphere of an inert gas such as argon, helium, nitrogen or the like.

It is also desirable to suitably control a heating rate to increase the active surface area. The heating rate of activation is preferably 1° C./min or more, more preferably 2° C./min or more, and preferably 20° C./min or less, more preferably 15° C./min or less.

To the surface of the alkali-activated, carbon fibers after alkali activation, an alkali metal hydroxide or the like that was used as an alkali activator adheres, and in order to remove such adhering matter, washing of the alkali-activated carbon fibers is carried out. As washing of the alkali-activated carbon fibers, water washing, acid washing or the like can be given.

Although the water washing method is not particularly limited, it is preferred, for example, that water washing be conducted by a method in which the alkali-activated carbon fibers are put into water, optionally stirred and dispersed, and subsequently collected by filtration. The water temperature when washing is preferably 30° C. or higher. The stirring and dispersing time is preferably 0.5 hours or longer.

The acid washing is carried out using a washing solution containing an inorganic acid, an organic acid or the like. By carrying out the acid washing, alkali metal hydroxide and the like used as an alkali activator can be efficiently removed.

Examples of the inorganic acid include hydrochloric acid, nitric acid, sulfuric acid, phosphoric acid, and the like. These inorganic acids may be used singly or in combination of two or more. When using an inorganic acid, the concentration of the inorganic acid in the washing solution is preferably about 0.5 to 20 mass %. The method of acid washing using an inorganic acid is not particularly limited, but, for example, the acid washing is preferably carried out by mixing the alkali-activated carbon fibers and the washing solution containing the inorganic acid and stirring the mixture at a temperature of 50° C. to 100° C. for 30 minutes to 120 minutes.

Examples of the organic acid include formic acid, oxalic acid, malonic acid, succinic acid, acetic acid, propionic acid and the like. These organic acids may be used singly or in combination of two or more. The concentration of the organic acid in the washing solution containing an organic acid is preferably about 0.5 to 20 mass %. In the method of acid washing using an organic acid, for example, the acid washing is preferably carried out by mixing the alkali-activated carbon fibers and the washing solution containing an organic acid and stirring the mixture at a temperature of 20° C. to 80° C. for 1. minute to 120 minutes.

The alkali-activated carbon fibers after washing are preferably dried at 80° C. to 150° C. for 0.5 hours to 24 hours.

The alkali-activated carbon fibers of the present invention have an increased active surface area and a high adsorption performance of polar substances. Accordingly, it is preferably used, for example, in the fields such as an adsorbent for a water cleaner (decomposing and removing residual chlorine, adsorbing and removing organic chlorine compounds such as trihalomethane, removing malodorous components and so on), a solvent recovery filter, an electric double layer capacitor, a catalyst and the like. It is also applicable to the fields of acoustic materials, heat insulation materials and the like by utilizing the increased specific surface area and the bulky shape of the activated carbon.

Furthermore, the activated carbon of the present invention is subjected to a heat treatment (for example, under an inert gas such as a nitrogen atmosphere) to remove functional groups from the activated carbon, whereby adsorption performance for harmful substances such as trihalomethane contained in water may be improved. Alternatively the activated carbon of the present invention is subjected to an oxidation treatment (for example, air oxidation, chemical oxidation or the like) to further impart a functional group to the activated carbon, whereby adsorption performance for polar substances such as water may be improved.

The present application claims priority to Japanese Patent Application No. 2012-166108 filed on Jul. 26, 2012. The entire contents of the disclosure of Japanese Patent Application No. 2012-166108 filed on Jul. 26, 2012 are incorporated herein by reference.

### EXAMPLES

The present invention will be illustrated in further detail with reference to experimental examples below. It should be noted, however, that these examples are never construed to limit the scope of the present invention; and various modifications and changes may be made without departing from the scope and sprit of the present invention described hereinbefore and hereinafter and should be considered to be within the scope of the present invention.

Each of samples used in Examples was produced as mentioned below.

### (Sample No. 1)

To 30 g of coal-pitch carbon fibers (length: 30 mm), potassium hydroxide as an alkali activator in an amount such that a mass ratio (alkali activator/activated carbon raw material) was to be 1.2 times was added and they were sufficiently blended with 100 ml of water, thereby obtaining the mixture. Next, this mixture was placed in a nitrogen stream (1 L/min), heated to 400° C. (heating rate: 10° C./min). kept for 30 minutes, subsequently heated up to 800° C. (heating rate: 10° C./min), and subjected to an alkali activation treatment for two hours.

The resulting activated matter was put in a container, 2 L of a hydrochloric acid aqueous solution (concentration: 5.25 mass %) was added thereto, and after heating to 100° C., boiling and stirring were conducted for one hour. Then, the activated matter was collected by filtration, and thus the acid washing was completed. Subsequently the activated matter that had been subjected to the acid washing was washed with 2 L of warm water (60° C.). The same operations were repeated until the pH of the filtrate became 6.5 or more. Subsequently the activated matter was boiled in 2 L of warm water (100° C.) for 1.5 hours, washed with 4 L of warm water (60° C.), and then dried for 12 hours at 110° C. whereby alkali-activated carbon fibers (Sample No. 1) were obtained.

### (Samples No. 2 to No. 4)

Alkali-activated carbon fibers (Samples No. 2 to No. 4) were obtained in the same manner as in the above Sample No. 1, except that the mass ratios of the alkali activators were changed to 2.0 times (Sample No. 2), 2.5 times (Sample No. 3) and 3.0 times (Sample No. 4), respectively.

### (Sample No. 5)

Alkali-activated carbon fibers (Sample No. 5) were obtained in the same manner as in the above Sample No. 1, except that 30 g of the carbon fibers (length: 70 mm) obtained by carbonizing phenolic resin fibers (manufactured by Gun Ei Chemical Industry Co., Ltd, KF-0270) as a raw material at 600° C. for two hours under a nitrogen atmosphere were used, and potassium hydroxide in a mass ratio of 1.0 times was used as an alkali activator.

### (Samples No. 6 to No. 8)

Alkali-activated carbon fibers (Samples No. 6 to No. 8) were obtained in the same manner as in the above Sample No. 5, except that the mass ratios of potassium hydroxides were changed to 2.0 times (Sample No. 6), 3.0 times (Sample No. 7) and 4.0 times (Sample No. 8), respectively.

### (Samples No. 9 and No. 10)

Steam-activated carbon fibers (Samples No. 9 and No. 10) were obtained by steam-activating cellulosic carbon fibers.

### (Sample No. 11)

Alkali-activated powdered activated carbon (Sample No. 11) was obtained in the same manner as in the above Sample No. 1, except that 30 g of coal-pitch coke in powder form (average particle size of 2 mm or less) were used as a raw material, and potassium hydroxide in a mass ratio of 3.5 times was used as an alkali activator.

### (Sample No. 12)

Steam-activated powdered activated carbon (Sample No. 12) was obtained by steam-activating phenolic resin.

### (Sample No. 13)

Alkali-activated powdered activated carbon (Sample No. 13) was obtained in the same manner as in the above Sample No. 1, except that 80 g of powdered carbon (average particle size of 2 mm or less) obtained by carbonizing a paper phenol resin compound as a raw material was used, and potassium hydroxide in the mass ratio of 2.5 times was used as an alkali activator.

The specific surface area and the active surface area of each of the samples prepared as described above were measured and the moisture adsorption rate of each of the samples Nos. 2. 3, 6 and 9 to 13 was determined.

### (Method for Measuring a Specific Surface Area)

After vacuum-drying the sample (0.2 g) at 150° C., a nitrogen adsorption isotherm was determined by measuring the adsorbed amount of nitrogen gas under a liquid nitrogen atmosphere (−196° C.) using a specific surface area and pore diameter distribution measurement device (ASAP-2400 manufactured by Shimadzu-Micromeritics Corporation), and the specific surface area (m²/g) was determined by the BET method.

### (Method for Measuring an Active Surface Area)

The sample pulverized by a disk mill (average particle size: 6 to 10 μm) was oxidized at 300° C. for 24 hours under air atmosphere, the amount of acidic surface functional group (meq/g) after oxidation was calculated by the following expression (2). and the active surface area (m²/g) was calculated by using an area occupied by one molecule of oxygen-containing compound as 0.083 nm².

[Expression 2]

Active surface area (m²/g)=a×10⁻³×b×c×10⁻¹⁸ (2)

a: Amount of acidic surface functional group after oxidation (meq/g)

b: 6.02×10²³(mol−1) Avogadro constant

c: 0.083 (nm²) Area occupied by one molecule of oxygen-containing compound

### (Method for Measuring an Amount of Acidic Functional Group)

The amount of acidic functional group was determined by following the Boehm method (the details are described in the “H. P. Boehm, Adzen. Catal, 16, 179 (1966)”). Specifically, first, 50 ml of sodium ethoxide solution (0.1 mol/l) was added to 2 g of the sample, and the resulting mixture was stirred for 2 hours at 500 rpm and then allowed to stand for 24 hours. After the lapse of 24 hours, the mixture was further stirred for 30 minutes and then separated by filtration. Hydrochloric acid of 0.1 mol/l was added dropwise to 25 ml of the resulting filtrate, and the titration amount of hydrochloric acid when the pH reached 4.0 was measured. Furthermore, as a blank test, hydrochloric acid of 0.1 mol/l was added dropwise to 25 ml of the above sodium ethoxide solution (0.1 mol/l), and the titration amount of hydrochloric acid when the pH reached 4.0 was measured. Then, the amount of acidic functional group was calculated by the following expression (3).

$$[ Expression 3 ]$$

$$Amount of acidic functional group ( meq \text{/} g ) = \frac{( a - b ) \times 0.1}{S \times 25 \text{/} 50} \qquad ( 3 )$$

a: Titration amount (ml) of hydrochloric acid in the blank test

b: Titration amount (ml) of hydrochloric acid when the sample was reacted

S: Mass (g) of the sample

### (Method for Measuring a Moisture Adsorption Rate)

1 g of the sample pulverized by a disk mill (average particle size of 6 to 10 μm) was collected. The sample (1 g) was dried at 115° C. for 24 hours, and then the mass of the sample was measured (mass A). The dried sample was placed in a thermo-hygrostat (manufactured by ESPEC Corp.: PR-1KPH) to a temperature of 25° C. and a relative humidity of 60%, kept for 24 hours, and then the mass of the sample was measured (mass B). A moisture adsorption rate (((mass B−mass A)/mass A)×100) was determined from the changes of the mass.

TABLE 1

| | | | | Specific | Amount of acidic | Active | Moisture |
|---|---|---|---|---|---|---|---|
| | | | | surface | surface functional | surface | adsorption |
| Sample | | Raw | Activation | area | group after oxidation | area | rate |
| No. | Shape | material | method | (m²/g) | (meq/g) | (m²/g) | (%) |
| 1 | Fiber | Coal pitch | Alkali | 1070 | 1.95 | 97.2 | — |
| 2 | | | activation | 1980 | 2.08 | 108.8 | 56.8 |
| 3 | | | | 2480 | 2.05 | 102.2 | 46.9 |
| 4 | | | | 2970 | 1.99 | 99.2 | — |
| 5 | | Phenolic resin | | 1120 | 2.16 | 108.1 | — |
| 6 | | | | 1740 | 2.16 | 107.9 | 53.0 |
| 7 | | | | 2520 | 2.16 | 107.9 | — |
| 8 | | | | 3090 | 1.83 | 91.5 | — |
| 9 | | Cellulose | Steam | 1330 | 0.94 | 47.2 | 35.0 |
| 10 | | | | 1670 | 0.83 | 41.4 | 31.3 |
| 11 | Powder | Coal pitch | Alkali | 2730 | 1.51 | 75.4 | 9.8 |
| | | | activation | | | | |
| 12 | | Phenolic resin | Steam | 1840 | 0.79 | 39.3 | 8.1 |
| 13 | | paper phenol | Alkali | 2350 | 1.58 | 78.7 | 19.8 |
| | | resin compound | activation | | | | |

*The “—” in the column of moisture adsorption rate means t at the measurement was no conducted.

Each of the alkali-activated carbon fibers (No. 1 to No. 8) had an increased active surface area of 80 m²/g or more. On the other hand, each of the steam-activated carbon fibers (No. 9 and No. 10), the alkali-activated powdered activated carbon (No. 11 and No. 13), and the steam-activated powdered activated carbon (No. 12) had an active surface area of 80 m²/g or less and had a low moisture adsorption rate.

1-7. (canceled)

8. An activated carbon having an active surface area of 80 m²/g or more.

9. The activated carbon according to claim 8, which comprises activated carbon fibers.

10. The activated carbon according to claim 8, which is used for adsorption.

11. The activated carbon according to claim 9, which is used for adsorption.

12. The activated carbon according to claim 10, which is used for adsorption of moisture in air.

13. The activated carbon according to claim 11, which is used for adsorption of moisture in air.

14. The activated carbon according to claim 8 having a moisture adsorption rate (((mass B−mass A)/mass A)×100) of 40% or more,
the moisture adsorption rate being determined from the mass A of the activated carbon after being dried at 115° C. for 24 hours and the mass B of the dried activated carbon after being kept for 24 hours in a thermo-hygrostat to a temperature of 25° C. and a relative humidity of 60%.

15. The activated carbon according to claim 9 having a moisture adsorption rate (((mass B−mass A)/mass A)×100) of 40% or more,
the moisture adsorption rate being determined from the mass A of the activated carbon after being dried at 115° C. for 24 hours and the mass B of the dried activated carbon after being kept for 24 hours in a thermo-hygrostat to a temperature of 25° C. and a relative humidity of 60%.

16. The activated carbon according to claim 8, which comprises an alkali-activated carbon.

17. The activated carbon according to claim 9, which comprises an alkali-activated carbon.

18. An adsorbent using the activated carbon according to claim 8.

19. An adsorbent using the activated carbon according to claim 9.
